(19) United States
(12) Patent Application Publication
(10) Pub. No.: US 2019/0090046 A1
(43) Pub. Date: Mar. 21, 2019

(54) Tactile Feedback for Audio Defined Menu System and Method

(71) Applicant: BRAGI GmbH, Munchen (DE)

(72) Inventor: Veniamin Milevski, Munchen (DE)

(73) Assignee: BRAGI GmbH, Munchen (DE)

(21) Appl. No.: 16/125,461

(22) Filed: Sep. 7, 2018

Related U.S. Application Data
(60) Provisional application No. 62/561,458, filed on Sep. 21, 2017.

(51) Int. Cl. H04R 1/10; G06F 3/16; G06F 3/01

(52) U.S. Cl. CPC H04R 1/1041; G06F 3/167; H04R 2420/07; G06F 3/016; G06F 3/017; H04R 1/1016

(57) ABSTRACT

An earpiece includes an earpiece housing, an intelligent control system disposed within the earpiece housing, a speaker operatively connected to the intelligent control system, a microphone operatively connected to the intelligent control system, and at least one sensor operatively connected to the intelligent control system for providing sensor data. The intelligent control system of the earpiece is configured to convey to the user a menu comprising a plurality of menu selections. The intelligent control system of the earpiece is configured to allow the user to navigate the menu using input from the at least one sensor. The intelligent control system of the earpiece is configured to provide non-voice feedback to the user as the user navigates the menu. The non-voice feedback may be audio feedback or tactile feedback. Tactile feedback may be provided by an actuator disposed within the earpiece housing such as a vibration motor.

### RELATED APPLICATIONS

This application claims priority to U.S. Provisional Application No. 62/561,458, filed Sep. 21, 2017, hereby incorporated by reference in its entirety.

### FIELD OF THE INVENTION

The present invention relates to wearable devices. More particularly, but not exclusively, the present invention relates to ear pieces including in-ear earpieces and ear phones.

### BACKGROUND

Wearable technology is a fast-developing field, and thus significant developments are needed in how users interact and interface with these technologies. Various alternatives exist for determining user intent in wearable technology exist. One such alternative is to use touch-based interfaces. Examples of touch-based interfaces may include capacitive touch screen, buttons, switches, pressure sensors, and finger print sensor. Another alternative is to use audio interfaces such as through use of key-word vocal commands or natural language spoken commands. Another alternative is to use a gesture based interface such that hand motions may be measured by some sensor and then classified as certain gestures. Yet another alternative is to use a computer-vision based interface such as by g. recognition of a specific individual, of a user's presence in general, or of two or more people.

Wearable technology presents particular challenges in that user-interfaces successful for established technologies are in some cases no longer the most natural, convenient, appropriate or simple interface for users. For example, large capacitive touchscreens are widely used in mobile devices but the inclusion of such a user interface may not be appropriate for discrete ear-worn devices.

Another one of the problems with using non-visual user interfaces is providing feedback to users. Therefore, what is needed are improved user interfaces for wearable devices which provide for feedback to the user without requiring visual feedback or audio feedback.

### SUMMARY

Therefore, it is a primary object, feature, or advantage of the present invention to improve over the state of the art.

Another object, feature, or advantage is to provide an improved user interface for a wearable such as an earpiece wearable.

It is a still further object, feature, or advantage of the present invention to provide for an interface which uses audio menus.

Another object, feature, or advantage of the present invention is to use sensor data such as inertial sensor data, biometric sensor data, and environmental sensor data to determine a user's attention or intention.

Yet another object, feature, or advantage of the present invention is to interact with a user without requiring manual input on a device and without requiring voice input to the device.

A further object, feature, or advantage of the present invention is to provide real-time tactile feedback to a user of an audio-defined menu system.

One or more of these and/or other objects, features, or advantages will become apparent from the specification and claims that follow. It is to be understood that different embodiments may have different objects, features, or advantages and therefore the claimed invention is not to be limited to or by any of the objects, features, or advantages provided herein.

According to one aspect, an earpiece includes an earpiece housing, an intelligent control system disposed within the earpiece housing, a speaker operatively connected to the intelligent control system, a microphone operatively connected to the intelligent control system, and at least one sensor operatively connected to the intelligent control system for providing sensor data. The intelligent control system of the earpiece is configured to convey to the user a menu comprising a plurality of menu selections. The intelligent control system of the earpiece is configured to allow the user to navigate the menu using input from the at least one sensor. The intelligent control system of the earpiece is configured to provide non-voice feedback to the user as the user navigates the menu. The non-voice feedback may be audio feedback or tactile feedback. Tactile feedback may be provided by an actuator disposed within the earpiece housing such as a vibration motor.

According to another aspect, an earpiece includes an earpiece housing, an intelligent control system disposed within the earpiece housing, a speaker operatively connected to the intelligent control system, a microphone operatively connected to the intelligent control system, and at least one sensor operatively connected to the intelligent control system for providing sensor data. The earpiece further includes a vibration motor operatively connected to the intelligent control system. The intelligent control system of the earpiece is configured to interface with a user of the earpiece by presenting audio cues associated with a menu containing a plurality of selections and generating feedback to the user by actuating the vibration motor in response to navigation of the menu.

According to another aspect, an earpiece includes an earpiece housing, an intelligent control system disposed within the earpiece housing, a speaker operatively connected to the intelligent control system, a microphone operatively connected to the intelligent control system, at least one inertial sensor operatively connected to the intelligent control system for providing inertial sensor data, and a vibration motor operatively connected to the intelligent control system. The intelligent control system of the earpiece is configured to interface with a user of the earpiece by presenting audio cues associated with a menu containing a plurality of selections and generating feedback to the user by actuating the vibration motor in response to navigation of the menu. The menu may include a plurality of different levels.

According to another aspect, a method for interacting with a user of an earpiece includes an earpiece housing, an intelligent control system disposed within the earpiece housing, a speaker operatively connected to the intelligent control system, a microphone operatively connected to the intelligent control system, at least one sensor operatively connected to the intelligent control system for providing sensor data, and an actuator disposed within the earpiece housing. The method includes presenting an audio menu to the user, the audio menu comprising a plurality of menu items and an audio cue associated with each of the menu items, receiving user input from the at least one sensor, navigating the audio menu based on the user input, and generating tactile feedback to the user based on the user input.

According to another aspect, an earpiece includes an earpiece housing, an intelligent control system disposed within the earpiece housing, a speaker operatively connected to the intelligent control system, a microphone operatively connected to the intelligent control system, at least one sensor operatively connected to the intelligent control system for providing sensor data, and a vibration motor operatively connected to the intelligent control system. The intelligent control system of the earpiece is configured to interface with a user of the earpiece by presenting audio cues associated with an audio menu containing a plurality of menu selections and generating feedback to the user by actuating the vibration motor in response to navigation of the audio menu. The menu may include a plurality of different levels. Each of the plurality of menu selections within a level of the audio menu are positioned at different spatial locations and wherein the earpiece includes one or more inertial sensors operatively connected to the intelligent control system, wherein the intelligent control system is used to determine head position such at the user navigates the audio menu using the head position as user input.

### BRIEF DESCRIPTION OF THE DRAWINGS

FIG. 1 illustrates one example of a set of earpieces which provide for user input to navigate an audio menu and feedback to a user's navigation of the audio menu.

FIG. 2 is a block diagram of one example of an earpiece.

FIG. 3 illustrates one example of making a selection from a menu of audio cues.

FIG. 4 illustrates an example of an audio menu.

FIG. 5 illustrates the wireless earpiece with an actuator used to provide tactile feedback.

FIG. 6 illustrates the wireless earpiece with a vibration motor used as the actuator to provide tactile feedback.

### DETAILED DESCRIPTION

The present invention relates to an audio-defined menu. An audio-defined menu is one in which the menu options are presented to a user audibly. Thus, an audio-defined menu provides one way for a user to interact with various devices including wearable devices such as earpieces and over-the-ear earphones. Although in an audio-defined menu the menu options may be presented to a user audibly, it is contemplated that the user may navigate the menu structure in different ways. For example, the user may scroll through an audio-defined menu using gestures where the device has a gestural control interface. The user may scroll through the audio-defined menu using head motion where one or more inertial sensors are used to determine head orientation and movement. For example, rotation clockwise or counterclockwise, nodding vertically, or nodding horizontally may be used to select different options. Sound may also be used to make selections for example, tongue clicks or other subtle sounds may be used to navigate the audio-defined menu.

The present invention provides for giving real-time feedback to a user who is navigating an audio-menu. The real-time feedback may be provided in various ways. For example, the real-time feedback may be tactile feedback such as a vibratory feedback. In one embodiment, the tactile feedback may be in the form of the scrolling of a wheel. Alternatively, the real-time feedback may be in the form of audio sounds. Alternatively, the real-time feedback may include both audio sounds and tactile feedback. Thus, movement within the audio menu hierarchy provides real-time feedback in order to create the sensation of movement through the menus and the sub-menus. In addition, where menu items are at known locations within the audio menu, a user will be able to navigate the menu structure more quickly as the user will not need to wait for the audio associated with each menu item.

Although, specific embodiments are shown and described with respect to earpieces or ear worn computers and sensor packages, it is to be understood that methodologies shown and described may be applied to other type of wearable devices including over-the-ear earphones.

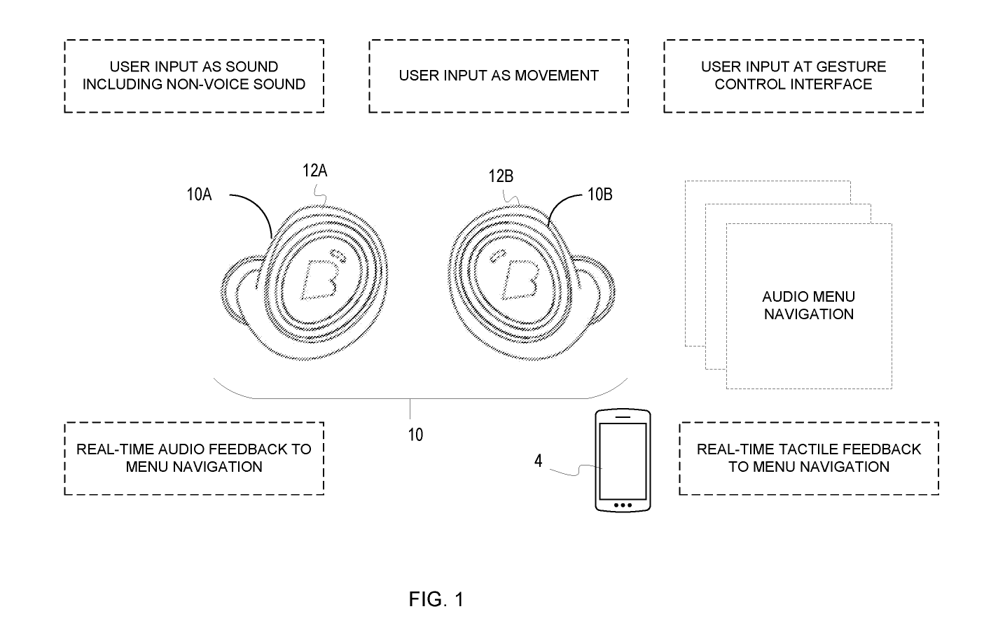

FIG. 1 illustrates one such example of a set of earpieces 10 which includes a first earpiece 10A and a second earpiece 10B which may be in the form of a left earpiece and a right earpiece. The first earpiece 10A has an earpiece housing 12A and the second earpiece 10B has a second earpiece housing 10B. One or more of the earpieces 10A, 10B may be in wireless communication with another device such as a mobile device 4. The earpieces 10 provide a user interface which allows a user to interact to navigate an audio menu. Thus, a user may provide user input as sound. The sound may be voice interaction or may be non-voice interaction such as the clicking of one's tongue. Where the user input is sound the sound may be detected using one or more microphones of the first earpiece 10A and/or the second earpiece 10B. The user input may be provided as movement such as head movement. Where the user input is movement, the user input may be detected such as by using one or more inertial sensors of the first earpiece 10A and/or the second earpiece 10B. The user input may be provided through a gesture control interface where gestures such as tapping or swiping are used. The gesture control interface may be provided in a number of different ways such as through optical sensing, capacitive sensing, imaging, or otherwise.

The set of earpieces 10 also provide for real-time feedback as a user navigates an audio menu. The real-time feedback may be provided in various ways. For example, the real-time audio feedback may be audio feedback such as in the form of a click, chime, musical note, musical chord, tone, or other audio icon. It is further contemplated that to assist in navigation of the audio menu, different audio icons may be assigned to different menu items. For example, tones of different frequencies may be used to indicate different menu items with a menu or sub-menu. Where audio feedback is used, the audio feedback may be provided by one or more speakers of either or both of the earpieces 10A, 10B. Real-time tactile feedback may also be used. The real-time tactile feedback may be in the form of a vibration such as may be generated by a vibration motor, or other actuator.

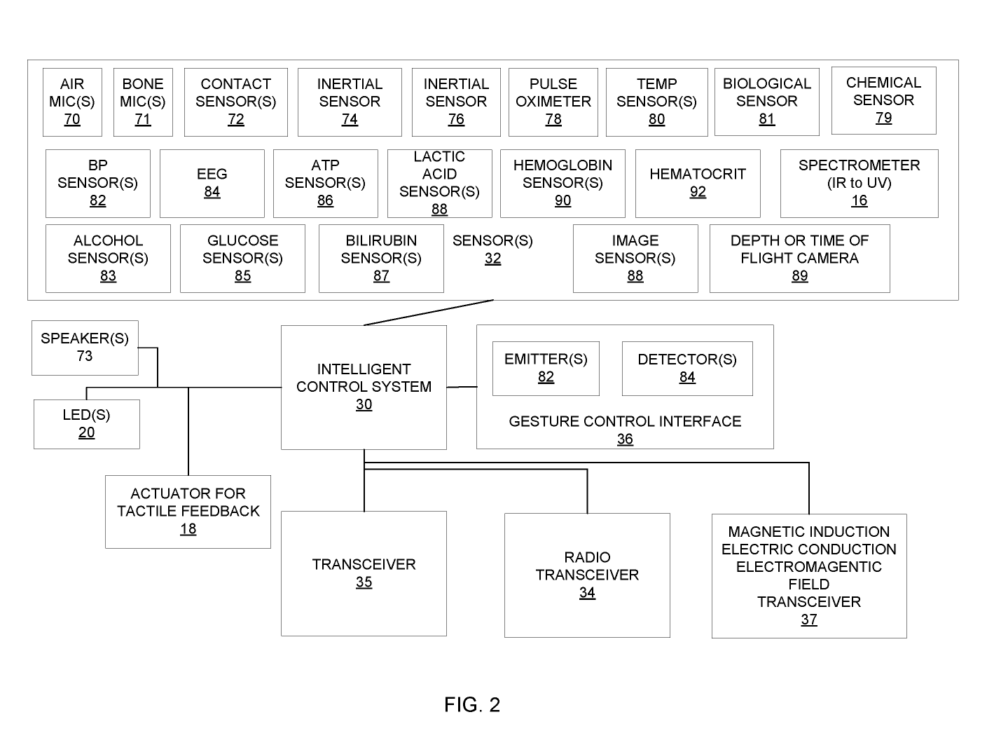

FIG. 2 is a block diagram illustrating a device which may be housed within the earpiece housing. The device may include one or more LEDs 20 electrically connected to an intelligent control system 30. The intelligent control 15 system 30 may include one or more processors, digital signal processors, microcontrollers, application specific integrated circuits, or other types of integrated circuits. The intelligent control system 30 may also be electrically connected to one or more sensors 32. Where the device is an earpiece, the sensor(s) may include an inertial sensor 74, another inertial sensor 76. Each inertial sensor 74, 76 may include an accelerometer, a gyro sensor or gyrometer, a magnetometer or other type of inertial sensor. The inertial sensors 74, 76 may be used to receive input from the user such as head movements or motions. The sensor(s) 32 may also include one or more contact sensors 72, one or more bone conduction microphones 71, one or more air conduction microphones 70, one or more chemical sensors 79, a pulse oximeter 76, a temperature sensor 80, or other physiological or biological sensor(s). Further examples of physiological or biological sensors include an alcohol sensor 83, glucose sensor 85, or bilirubin sensor 87. Other examples of physiological or biological sensors may also be included in the device. These may include a blood pressure sensor 82, an electroencephalogram (EEG) 84, an Adenosine Triphosphate (ATP) sensor, a lactic acid sensor 88, a hemoglobin sensor 90, a hematocrit sensor 92 or other biological or chemical sensor. Other types of sensors may be present

A spectrometer 16 is also shown. The spectrometer 16 may be an infrared (IR) through ultraviolet (UV) spectrometer although it is contemplated that any number of wavelengths in the infrared, visible, or ultraviolet spectrums may be detected. The spectrometer 16 is preferably adapted to measure environmental wavelengths for analysis and recommendations and thus preferably is located on or at the external facing side of the device. An image sensor 88 may be present and a depth or time of flight camera 89 may also be present. A gesture control interface 36 may also be operatively connected to or integrated into the intelligent control system 30. The gesture control interface 36 may include one or more emitters 82 and one or more detectors 84 for sensing user gestures. The gestures performed may be performed such as through contact with a surface of the earpiece or may be performed near the earpiece. The emitters may be of any number of types including infrared LEDs. The device may include a transceiver 35 which may allow for induction transmissions such as through near field magnetic induction. The gesture control interface 36 may alternatively rely upon capacitive sensing or imaging such as with a camera. A short range transceiver 34 using Bluetooth, BLE, UWB, or other means of radio communication may also be present. The short range transceiver 34 may be used to communicate with other devices including mobile devices. The various sensors 32, the intelligent control system 30, and other electronic components may be located on one or more printed circuit boards of the device. One or more speakers 73 may also be operatively connected to the intelligent control system 30. A magnetic induction electric conduction electromagnetic (E/M) field transceiver 37 or other type of electromagnetic field receiver may also operatively be connected to the intelligent control system 30 to link it to the electromagnetic field of the user. The use of the E/M transceiver 37 allows the device to link electromagnetically into a personal area network or body area network or other devices. It is contemplated that sensors associated with other devices including other wearable devices or internet of things (IoT) devices may be used to provide or add to sensor data which may be used in providing user input to navigate an audio menu.

An actuator 18 is provided which may provide for tactile feedback to a user. The actuator 18 may take on any number of different forms. In one embodiment, the actuator 18 may advance a wheel providing tactile feedback, so that each time the wheel advances in one direction the user may feel the movement or vibration associated therewith. The wheel may advance in a forward or backward direction in accordance with the user's navigation of an audio menu. In other embodiments, the actuator 18 may be a vibration motor. For example, the 18 may be an eccentric rotating mass (ERM) motor or a linear resonant actuator (LRA) motor. Thus, each time user input from a user registers as input to the audio menu, a vibration may occur to confirm the input. Of course, other types of vibration motors or other types of actuators may be used. The actuator 18 may be disposed within the housing of the wireless earpiece set or other device.

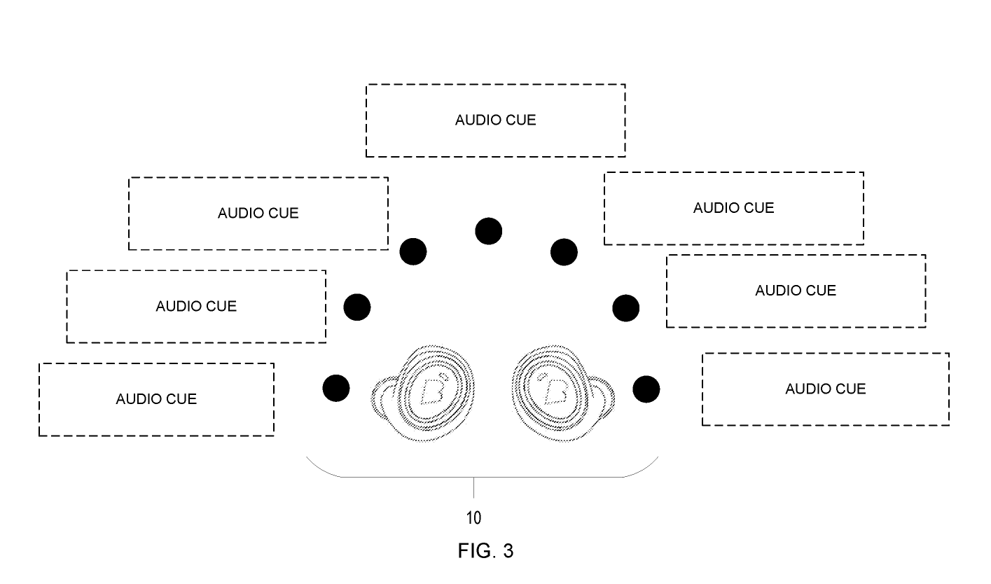

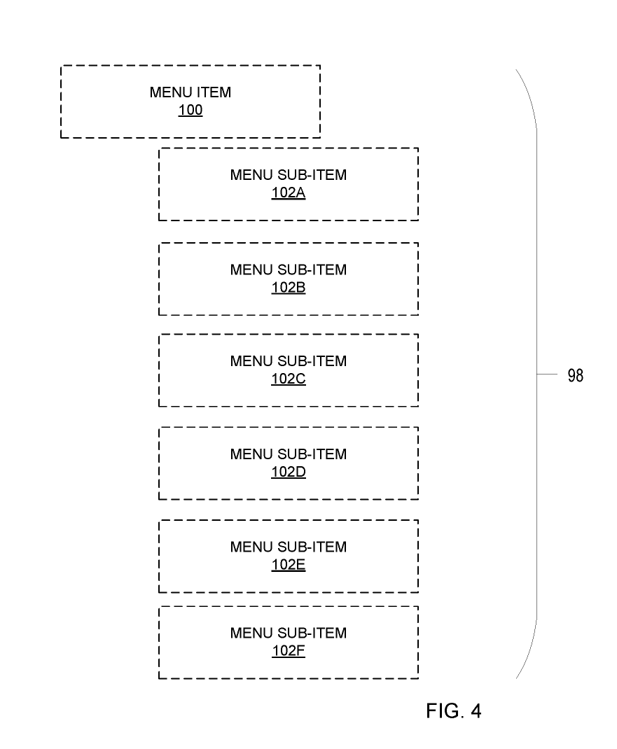

The audio menu is implemented such that when the interface is awake and/or active, the user may be presented with different audio prompts thereby allowing them to navigate a menu and make a menu selection. In one alternative, sounds may be played to user according to their (the user's) orientation. FIG. 3 illustrates such an example. The sounds may be in the form of language or may be other types of audio icons or audio cues where particular sounds or combinations of sounds associated with a selection may have different meanings, preferably intuitive meanings to better convey different selections including different selections within a menu of selections. The audio cues may convey position information as well as a description for the selection. Thus, for example, one selection may be associated with a user facing directly ahead (or a 12 o'clock position), another selection may be associated with a slight turn to the right or clockwise (1 o'clock), another selection may be associated with a larger turn to the right or clockwise (2 o'clock), another selection may be associated with being turned even further to the right or clockwise (3 o'clock). Similarly, additional selections may be associated with a slight turn to the left or counter-clockwise (11 o'clock), a greater turn to the left or counter-clockwise (10 o'clock), or an even greater turn to the left (9 o'clock). Thus, an audio prompt may include “9” or “9 o'clock” and be accompanied by words or sounds associated with a particular selection. Other selections may be provided in the same way. Thus, in this simple arrangement, up to seven different selections may be given to a user. Although it is contemplated that more or fewer selections may be present and they may be more than one level of selections present. For example, a menu may be present with multiple levels and by selecting one selection within a level of the menu, the user may be presented with additional selections. FIG. 4 illustrates that a single menu item or selection 100 of an audio menu 98 may have a plurality of additional plurality of items 102A, 102B, 102C, 102D, 102E, 102F associated with it. There may be any numbers of different levels of items present in an audio menu. An audio menu is an audio presentation of a plurality of items from which a user may select.

The audio menu may be persistent in that the same audio menus may be used with the same menu options positioned in the same location. One advantage of this arrangement is that a user may remember the location of each menu item. Thus, instead of needing to listen to audio presenting each selection, the user can rely on the non-voice feedback as they navigate through the selections. Examples of non-voice feedback can be tones or other audio sounds or tactile feedback.

It also to be understood that the menus provided may be built dynamically to present the items in an order generated to present the most likely selections first. A determination of the most likely selections may be performed in various ways including based on user history, user preferences, and/or through using other contextual information including sensor data.

According, to another example with a more natural attention-detection mechanism, the user may be presented various audio cues or selections at particular locations. Audio feedback or cues may be processed with a psychoacoustic model to virtually place or move sounds in 3D space relative to the user. Thus, for example, different audio cues or selections may be placed in different locations, such as up, down, right, left, up and to the right, down and to the right, down and to the left. Of course, any number of other locations may be used. It should be understood that in this example, the audio cues need not include position information. Instead, the position is associated with the perceived location or direction of the sound source. Audio or tactile feedback may be provided to a user when it is determined that the user has navigated the audio menu such as to make a selection of a menu item or a sub-menu.

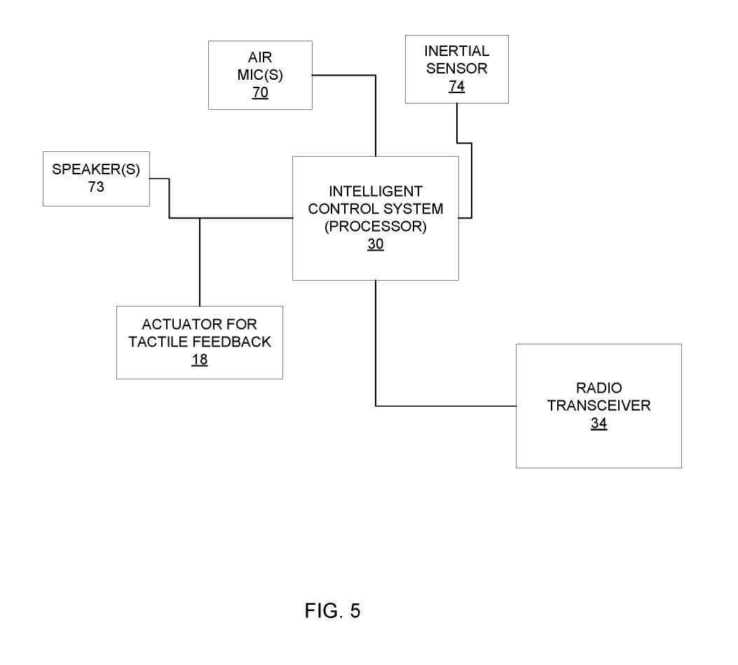

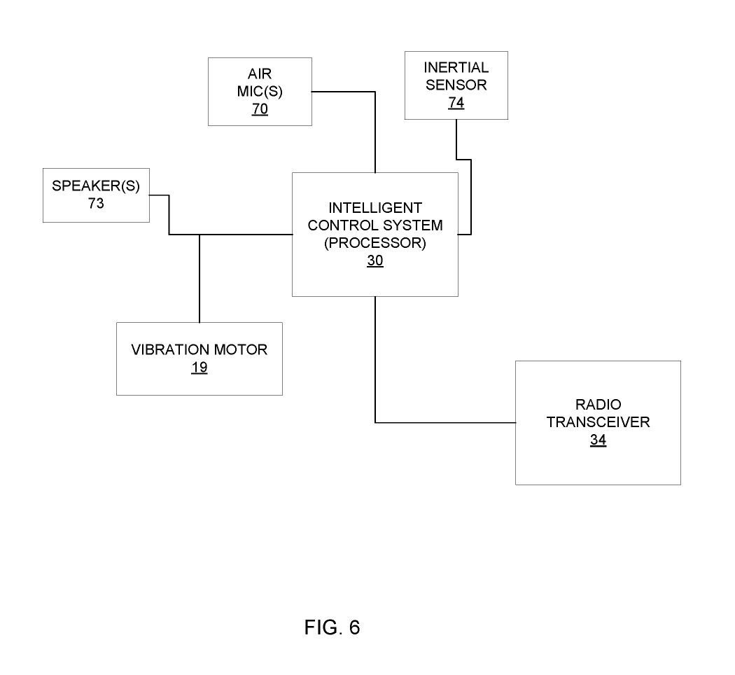

FIG. 5 illustrates another example of a wireless earpiece. In FIG. 5, the wireless earpiece includes an intelligent control system which may be a processor 30. At least one inertial sensor 74 is operatively connected to the intelligent control system 30. One or more microphones 70 may also be operatively connected to the intelligent control system as may be one or more speakers 73. An radio transceiver 34 may also be operatively connected to the intelligent control system 30. An actuator for tactile feedback 18 is also operatively connected to the intelligent control system 30. FIG. 6 is similar except that a vibrator motor 19 is shown which is one example of an actuator which may be used for providing tactile feedback.

Although various examples have been shown and described throughout, it is to be understood that numerous variations, options, and alternatives and contemplated. This includes variations in the sensors used, the placement of sensors, the manner in which audio menus are constructed, the type of feedback provided, the components used to provide the feedback, and other variations, options, and alternatives.

What is claimed is:

1. An earpiece comprising:
an earpiece housing;
an intelligent control system disposed within the earpiece housing;
a speaker operatively connected to the intelligent control system;
a microphone operatively connected to the intelligent control system;
at least one sensor operatively connected to the intelligent control system for providing sensor data;
wherein the intelligent control system of the earpiece is configured to convey to the user a menu comprising a plurality of menu selections;
wherein the intelligent control system of the earpiece is configured to allow the user to navigate the menu using input from the at least one sensor;
wherein the intelligent control system of the earpiece is configured to provide non-voice feedback to the user as the user navigates the menu.

2. The earpiece of claim 1 wherein the non-voice feedback is audio feedback.

3. The earpiece of claim 1 wherein the non-voice feedback is tactile feedback and wherein the earpiece further comprises an actuator disposed within the earpiece housing for providing the tactile feedback.

4. The earpiece of claim 1 wherein the actuator is a vibration motor.

5. The earpiece of claim 1 wherein the audio menu comprises a plurality of levels.

6. The earpiece of claim 1 wherein each of the plurality of menu selections within a level of the menu are positioned at different spatial locations and wherein the earpiece includes one or more inertial sensors used to determine head position such at the user navigates the menu using the head position as user input.

7. The earpiece of claim 1 wherein the input is non-voice audio input.

8. An earpiece comprising:
an earpiece housing;
an intelligent control system disposed within the earpiece housing;
a speaker operatively connected to the intelligent control system;
a microphone operatively connected to the intelligent control system;
at least one sensor operatively connected to the intelligent control system for providing sensor data;
a vibration motor operatively connected to the intelligent control system;
wherein the intelligent control system of the earpiece is configured to interface with a user of the earpiece by presenting audio cues associated with an audio menu containing a plurality of menu selections and generating feedback to the user by actuating the vibration motor in response to navigation of the audio menu.

9. The earpiece of claim 8 wherein the menu comprises a plurality of levels.

10. The earpiece of claim 8 wherein each of the plurality of menu selections within a level of the audio menu are positioned at different spatial locations and wherein the earpiece includes one or more inertial sensors operatively connected to the intelligent control system, wherein the intelligent control system is used to determine head position such at the user navigates the audio menu using the head position as user input.

11. An earpiece comprising:
an earpiece housing;
an intelligent control system disposed within the earpiece housing;
a speaker operatively connected to the intelligent control system;
a microphone operatively connected to the intelligent control system;
at least one inertial sensor operatively connected to the intelligent control system for providing inertial sensor data;
a vibration motor operatively connected to the intelligent control system;
wherein the intelligent control system of the earpiece is configured to interface with a user of the earpiece by presenting audio cues associated with an audio menu containing a plurality of selections and generating feedback to the user by actuating the vibration motor in response to navigation of the menu.

12. The earpiece of claim 11 wherein the audio menu comprises a plurality of levels.

13. The earpiece of claim 11 wherein each of the plurality of menu selections within a level of the audio menu are positioned at different spatial locations and wherein the inertial sensor data is used by the intelligent control system to determine head position such at the user navigates the audio menu using the head position as user input.
